(19) United States
(12) Patent Application Publication
(10) Pub. No.: US 2003/0223748 A1
(43) Pub. Date: Dec. 4, 2003

(54) System and method for seamless spectral control

(76) Inventors: Timothy D. Stowe, Alameda, CA (US); Eric K. Gustafson, Palo Alto, CA (US); David M. Bloom, Wilson, WY (US); Asif A. Godil, Fremont, CA (US)

Correspondence Address: PILLSBURY WINTHROP LLP, 2550 Hanover Street, Palo Alto, CA, 94304-1115, US

(21) Appl. No.: 10/371,907

(22) Filed: Jun. 16, 2003

Related U.S. Application Data
(60) Provisional application No. 60/359,167, filed on Feb. 20, 2002.

(51) Int. Cl. H04J 14/02

(52) U.S. Cl. 398/48

(57) ABSTRACT

A design for a 1×N Optical Wavelength Switch incorporates mode conditioning optics which allows seamless control between actuators thus making possible increased channel count (decreasing the channel grid from 100 GHz to 50 GHz) and combining optical channels into groups which can be controlled as a band. In an exemplary embodiment, a new device referred to herein as a Diffractive Steering Element (DSE) is used to implement the invention in a 1×N wavelength selective switch which provides power equalization on a channel-by-channel basis.

### FIELD OF THE INVENTION

The present invention relates to systems and method for optical switching a wave division multiplexed (WDM) signals, and more particularly relates to optical switches for WDM signals wherein the channel count can be increased without significant performance degradation.

### BACKGROUND OF THE INVENTION

In today's WDM networking systems it is becoming increasingly important to be able to dynamically attenuate, spectrally equalize, and switch individual wavelengths on the ITU grid using an optically transparent architecture. Most optically transparent architectures route and modulate individual wavelength channels in a manner similar to the architecture shown in FIG. 1A. At present, such systems are mainly built from discrete components including an input P1 which may go through a circulator P2 and bidirectionally communicate with an array of WDM multiplexers (MUX) P3 & demultiplexers (DEMUX) P4, arrays of discrete variable optical attenuators (VOAs) P5, and a 1×N switching fabric P6 that handles traffic in one or both directions. However, systems built with discrete components are complex, costly and unreliable.

Moreover, the prior art also suffers from a lack of uniformity that substantially limits expandability.

However, all of the prior art approaches, whether liquid crystal based or otherwise, suffer a common limitation in that they all create a pixelation of the output light across the wavelength spectrum. This pixelation is caused by the dead space between individual actuators and in conventional systems leads to sharp attenuation discontinuities in wavelength regions in between those wavelengths specified on the ITU grid. This problem prohibits the flexible grouping of individual wavelengths into sub-bands that could be switched or amplified as a single unit.

Despite the benefits of these developments, the sum result has been that the effects of deadspace between individual microactuators has been reduced but never entirely eliminated. A typical response curve for a prior art device is shown in FIG. 1B [PRIOR ART], which illustrates coupling efficiency from the input fiber to an output fiber of a switch made using 80 micron tilting mirrors with a nominal gap on the order of 1 μm between the actuators. More particularly, FIG. 1B illustrates the large insertion loss defect or spectral “bump” at the interface between two adjacent actuators when a conventional tilting mirror arrangement is used. Note that while actuators A and B have no insertion loss there is a substantial discontinuity between the actuators. Seven gap sizes from 0 to 1.5 μm are used in the calculations and as expected as the gap increases the size of the defect, or spectral “bump”, increases.

There has therefore been a need for a WDM system and method that, among other things, allows for individually modulating channels while seamlessly transitioning among them, and which also makes the effects of deadspace inconsequential and therefore eliminates concerns about pixelation,

### THE FIGURES

FIG. 1A illustrates in block diagram form a conventional, prior art approach to optical switching in an ITU grid.

FIG. 1B [PRIOR ART] illustrates coupling efficiency from the input fiber to an output fiber of a conventional switch made using tilting mirrors with a gap between the actuators.

FIG. 2 illustrates an implementation of a channel-controlling device in accordance with the present invention in which actuator extent and optical channel positions are shown in both the frequency and the spatial domains, wherein the grating disperses the light across the MEMS device so each frequency band corresponds to a physical position on the MEMS array, with each optical channel associated with a single actuator.

FIG. 3 illustrates a modification of FIG. 2 in which additional channels have been added between the existing channels, and the actuators have been reallocated such that each actuator now controls a band of channels. The result is that FIG. 3 shows actuator extent and optical channel position in the frequency domain for a band-controlling device.

FIG. 4A illustrates in plan view an exemplary optical switching system also capable of providing equalization in accordance with the present invention. The implementation shown is a free space grating system incorporating mode conditioning optics and diffractive steering element (“DSE's”) to couple optical channels from an input fiber into one of a plurality of output fibers while providing equalization on a channel-by-channel basis. In this embodiment a prism pair beam expander included for further expantion of the input beam along one axis.

FIG. 4B shows a 1×N microcollimator array as might be used in the system of FIG. 4A, together with an associated telescope beam expander.

FIG. 4C shows another detailed portion of the system of FIG. 4A, in particular the diffraction grating, achromatic lens and diffractive steering elements.

FIG. 4D shows an alternative to the embodiment of FIG. 4A, including the use of beam expanders as well as a single input fiber with a recirculator, such as may be desired in certain applications such as a dynamic channel equalizer.

FIGS. 5A-D illustrate a general layout of a Diffractive Steering Element (DSE) formed from subelements and showing three possible actuator control schemes, with a relative spot size of a typical channel shown by the circle in the lower left in FIGS. 5A-5C. In FIG. 5A, each subelement receives its own individual command signal which allows maximum control but has many command signals. In FIG. 5B the subelements are ganged to reduce the number of control signals required for each actuator to two, but this arrangement is also capable of providing equalization as well as steering. In FIG. 5C each actuator has only one command signal and provides steering only. FIG. 5d shows a side view of how a subelement could be formed from asingle cantilever actuator.

FIG. 6 illustrates in plan view a cantilever-based Diffractive Steering Element in which each actuator has a diffractive optical reflective surface and the flexible cantilever is actuated using electrostatic force.

FIG. 7 illustrates in a plan view the preferred embodiment of a diffractive steering element array based upon a torsional actuators wherein the pivot is within the actuator to permit close packing of the actuators and allow for the use of small gaps.

FIG. 8 illustrates a technique for doubling the steering angle through the use of a seamless actuator and a double pass.

FIG. 9 illustrates a technique for linearizing the V-squared forces on the cantilever elements.

FIG. 10 shows in plot form, as a function of frequency, the coupling across three actuators for three different deflections of actuator 2. When the deflection is zero the light from actuator 2 is coupled from the input fiber back into the input fiber just as in actuator 1 and 3. As the deflection angle is increased to 3Δθ, where Δθ is the beam divergence half-angle, the coupling increases until it reached the insertion loss level.

FIGS. 11A-B illustrate the coupling efficiency as a function of frequency across three actuators for five different gap spacings “b” and a pitch on the order of 10 microns. In the implementation shown, actuator 2 is deflecting 3Δθ to produce maximum coupling to one of the output fibers. FIG. 11b is an expanded view of actuator 2 and shows the residual ripple due to the gaps between the cantilevers. For a gap of 1 μm the peak to peak ripple is less than 0.1 dB and the excess insertion loss is less than 1.0 db for a spot size of eight microns nominally.

FIGS. 12A-B illustrate the coupling efficiency as a function of frequency across three actuators for five different gap spacings “b”. This is the substantially the same plot as FIGS. 11A-B except the nominal spot size is doubled to 16 μm, and shows that the ripple is now negligible while the insertion loss is the same as with the smaller spot.

FIG. 13 illustrates insertion loss as a function of the gap-period ratio and shows a linear relationship, IL=9.3*b/p where b is the gap width, p is the period and IL is the insertion loss in dB.

FIGS. 14A-B illustrate the coupling efficiency as a function of frequency across four actuators for a gap of 1 μm with two of the actuators 2 and 3 deflecting 3Δθ to produce maximum coupling to one of the output fibers. FIG. 14B is an expanded view of coupling across the actuators of FIG. 14A, and illustrates that the region between the two actuators provides a response which is substantially smooth and seamless.

FIG. 15 illustrates optically a criteria implemented in the present invention for reducing to an inconsequential level the discontinuities associated with gaps between actuators which has heretofore prevented substantially seamless expansion of the channel count.

### SUMMARY OF THE INVENTION AND DESCRIPTION OF THE PREFERRED EMBODIMENTS

The present invention overcomes many of the limitations of the prior art by providing a substantially integrated solution for dynamically attenuating, spectrally equalizing, and switching individual wavelengths on the ITU grid using an optically transparent architecture. In addition, the present invention provides ready expandability for achieving dynamic control with increasing channel counts and bandwidth requirements. In particular, these features are illustrated in the context of an embodiment of the invention in a 1×N channel-based optical switch capable of increased channel count operation and equalization without significant operational impairment.

In particular, what is desired is a set of adjacent optical modulators that have no boundaries in the frequency domain. (By optical modulators we mean elements which may manipulate the transmission, reflection, or direction of light to provide attenuation and/or switching capabilities. Such modulators could be formed from liquid crystal elements or micromechanical elements for example.) In other words, it is one aspect of the present invention to make possible a system where, if every actuator were set to produce the same attenuation, the entire attenuation spectrum would be flat, although the present invention need not be so limited. Such a seamless system makes the effects of deadspace inconsequential and reduces or eliminates concerns about pixelation. Such a seamless system allows WDM systems to be reconfigured from 100 GHz to 50 GHz systems or even to 25 GHz entirely through software.

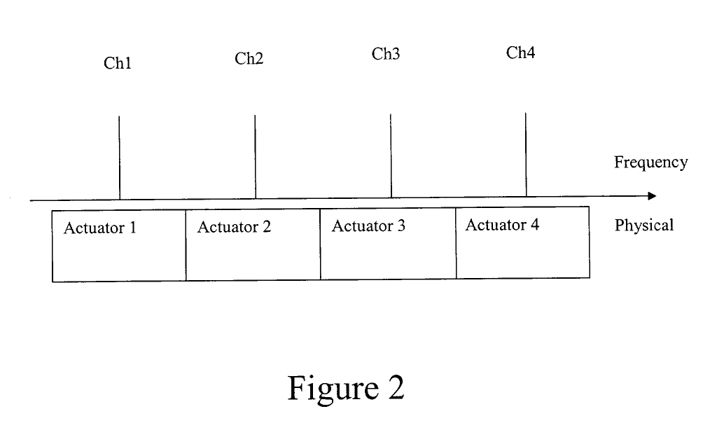

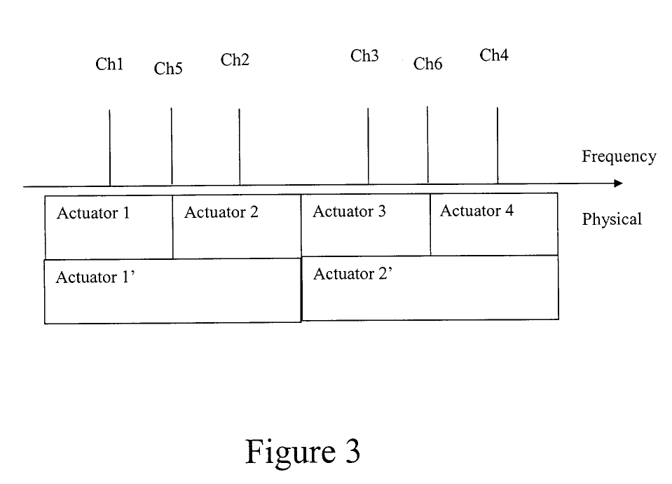

To better appreciate the various aspects of the present invention relating to switching, blocking and equalizing channels, the differences between channel control and band control should be clearly in mind. FIG. 2 shows a channel and actuator scheme implemented in a 1×N channelized switch (with the vertical lines for each channel representing the center frequency of that channel); FIG. 3 shows the same switch used in a band-controlling mode.

Channelized devices have a one-to-one correspondence between actuators and optical channels. FIG. 2 illustrates an exemplary arrangement which comprises four optical channels evenly spaced in frequency and each controlled by an actuator that also subtends a range of frequencies that would affect any channel within this range; it will be appreciated from the teachings herein that the dimensions . In the arrangement of FIG. 2, Actuator 1 controls Channel 1 and only channel 1 while Actuator 2 controls only Channel 2, etc. If more capacity is required in this implementation, additional optical channels may be added between the existing channels, as shown in FIG. 3. Thus, channel 5 is now inserted between channels 1 and 2, and channel 6 is inserted between channels 3 and 4. However, this addition of channels 5 and 6 may not be possible unless the actuators are designed in a fashion that allows them to be used in pairs and redefined as a new actuator for the control of the new group of channels. Thus, Actuators 1 and 2 become Actuator 1′ and Actuators 3 and 4 becomes Actuator 2′, etc. The new actuator 1′ now controls channels 1, 5 and 2, and Actuator 2′ now controls channels 3, 4 and 6. Thus, each actuator now controls a band of channels—in this case a band consisting of 3 channels. More channels (7, 8, etc.) could be added between the existing channels making up the band if required in the future, and the controls would be expanded as discussed above.

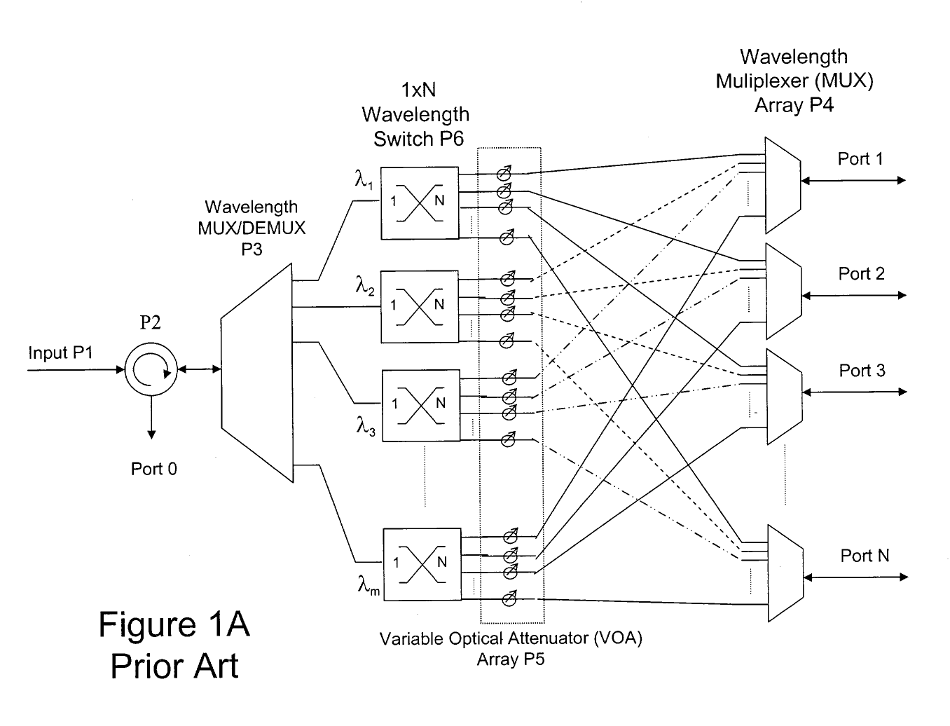

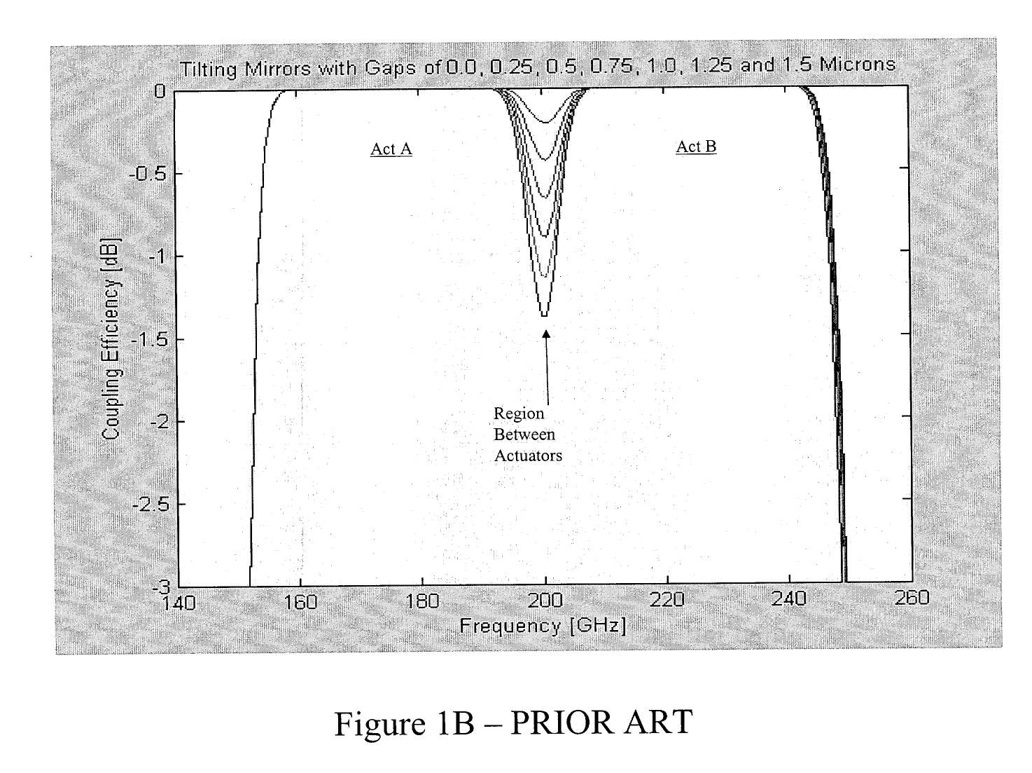

However, note that channel 5 in FIG. 3 sits in a region exactly between the actuators 1 and 2, and spans the boundary between those actuators. In conventional systems, this boundary has been discovered to represent a discontinuity, or what may be thought of as a spectral “bump” which is unpredictable in direction and amplitude and therefore may introduce significant error [shown, for example, in FIG. 1B as discussed above.] As a result, the reallocation of actuator authority [from Actuators 1 and 2 to Actuator 1′] is only possible if the actuators are designed in such a way that the region between actuators looks to the light identical to the rest of the actuator. Such a design may be thought of as being seamless. This design of seamless actuators is another aspect of the present invention.

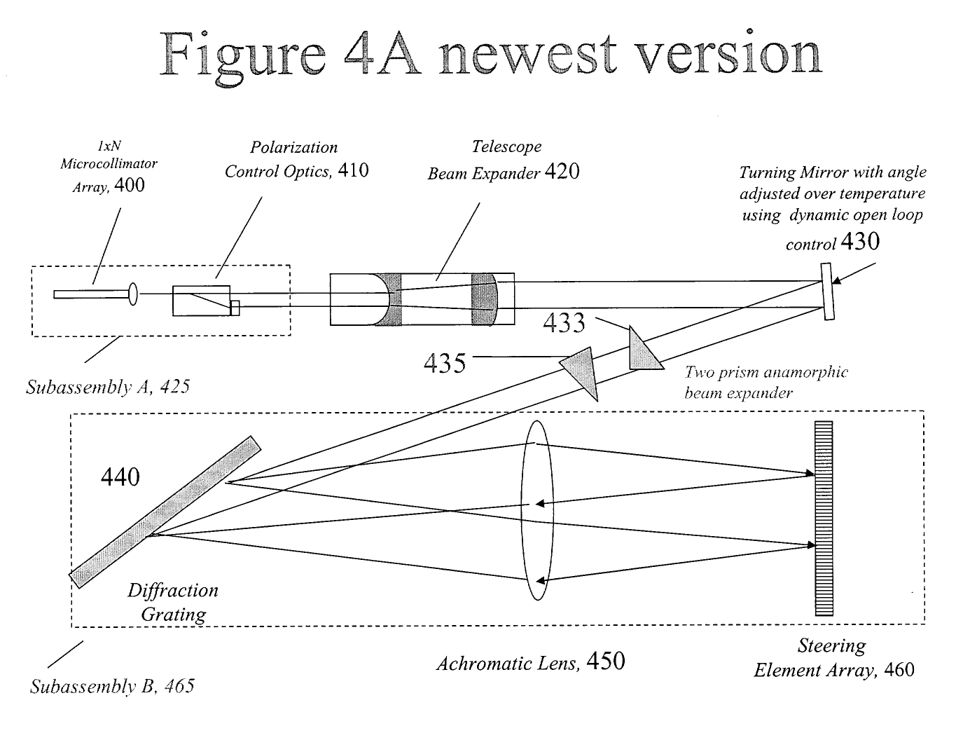

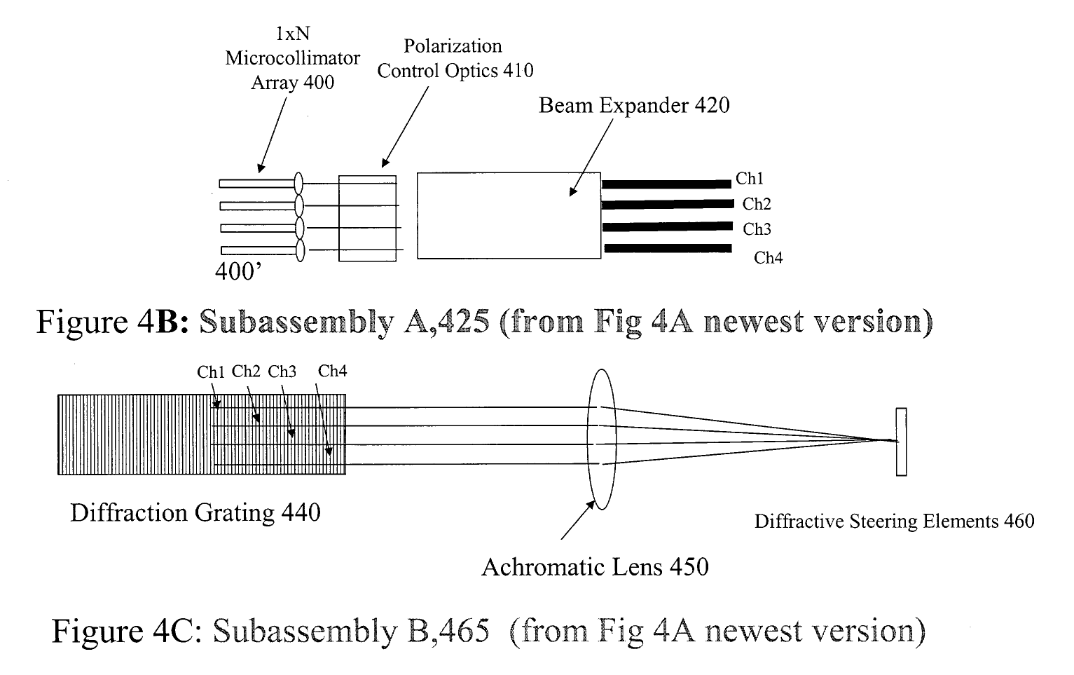

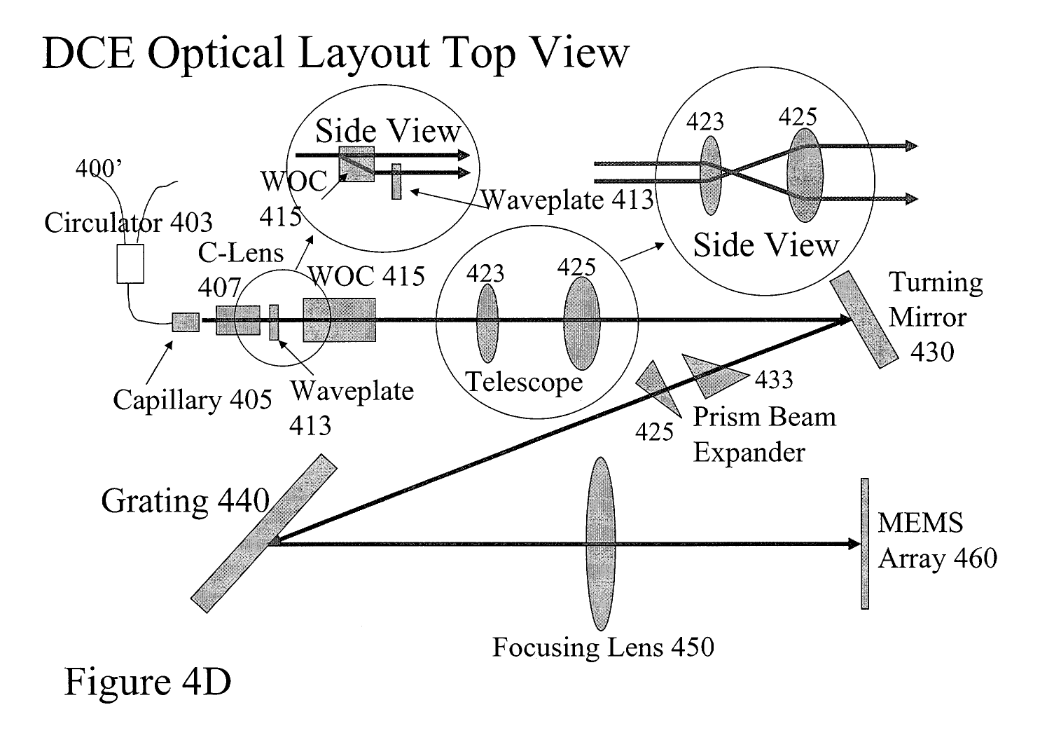

One embodiment of an integrated approach is shown in FIGS. 4A-C, which show an approach to a system that combines free space optics and a diffraction grating to simultaneously multiplex and demultiplex individual wavelengths from several different input and output ports. This approach is described in more detail below. The arrangement of FIGS. 4A-C also permits manipulating the intensity of and/or switching the path of individual wavelength channels and, as also discussed in greater detail below, substantially overcomes the pixelation issue common among the prior art.

To design and build a WDM system that is capable of providing seamless performance as discussed above, the present application discloses a MEMS based actuator denominated as a Diffractive Steering Element or DSE. Used in accordance with the invention, an array of DSEs allows individual wavelength channels to be seamlessly steered to a plurality of outputs while also seamlessly managing the wavelength regions between the ITU grid.

The DSE allows systems to be configured to manipulate light while entirely eliminating the deleterious optical effects caused by deadspace between the actuators. While these actuators can be operated in the same manner as micro-mirrors (i.e. by electrostatic means), they incorporate a periodic amplitude grating which functions to eliminate, along at least one direction, issues related to optical pixelation or a spectral bumps between the actuators.

System Description

DSE-based actuators are designed to be used, in one example, in a 1×N wavelength switching device based upon the grating architecture shown in FIGS. 4A-C. When used in this architecture, the optical spectrum can be seamlessly controlled between adjacent wavelength channels on the ITU grid. FIGS. 4A-C show a 1×N Optical switch that includes an array 400A of N+1 optical fibers with micro lens coupling 400B arrayed as a microcollimator array 400 in a vertical plane. One fiber 400′ is the input fiber and the other N fibers are the output fibers, as best shown in FIG. 4B. The light from the input fiber 400′ passes through polarization control or diversity optics 410, including in at least some embodiments a walk off crystal and a wave plate, that separates the light into two orthogonal polarizations and then rotates one of the polarizations so that both are aligned with the low loss orientation of the dispersive (grating, GRISM, etc.) element. The beams are expanded with a beam expander 420, which may for example be a telescope, a set of prisms 433 & 435, or other suitable device, which results in a plurality of beams representative of the channels carried by the input beam. To save space, although not optically required and not used in all embodiments, a mirror 430 may be used to fold the beam. However, in some embodiments it may be desirable to include a mirror whose reflective angle may adjusted slightly to allow for tuning the incident angle of the input beam onto a dispersive element such as a grating. The expanded beam is then passed to a dispersive element 440, which may for example be a diffraction grating or other suitable device. The dispersed light (spread out in the horizontal plane) is then passed through a lens 450, which may be achromatic in at least some embodiments, and falls on an array of diffractive steering elements (DSE) 460 that can steer the light in the vertical plane. In the plane of the DSE, the beam is small in the direction of the dispersion of the dispersive element and relatively larger in the direction orthogonal to this direction. This latter direction is the direction in which the beams are deflected by, for example, the DMEMs beam steering cantilever arrays which comprise the DSEs. These cantilever arrays are used to redirect the light in the vertical direction and to couple the light from the input fiber to any of the other fibers. Moreover, by adjusting the deflection angle and thus the transverse position of the beam at the output fiber it is possible to control the amount of light coupled into the output fibers allowing controlled attenuation as well as steering.

FIG. 4D shows an alternative arrangement to the embodiment of FIG. 4A. For ease of reference, like elements have been assigned the same reference numerals as used in connection with FIG. 4A. FIG. 4D can be seen to include an input fiber array but instead of the 1×N array illustrates the use of a circulator 403 and capillary lens 405 optically aligned with the collimating lens 407. The polarization control optics 410 are illustrated in greater detail in the form of a waveplate 413 and walk-off crystal 415, and a first stage of beam expander 420 can be seen, in this arrangement, to comprise a pair of lenses 423 and 425 which effectively operate as a telescope. The turning mirror 430 is optional as in the arrangement of FIG. 4A. A second stage of beam expansion may also be provided, and in the arrangement of FIG. 4D is illustrated as a pair of prisms 433 and 435. The expanded beam is then provided to the dispersive element 440, which may again be a grating. The beam is substantially spread by the grating and passed through the lens 450, which focuses the beams on the DSE array 460 just as with FIG. 4A. As with FIG. 4A

Diffractive Steering Element (“DSE”)

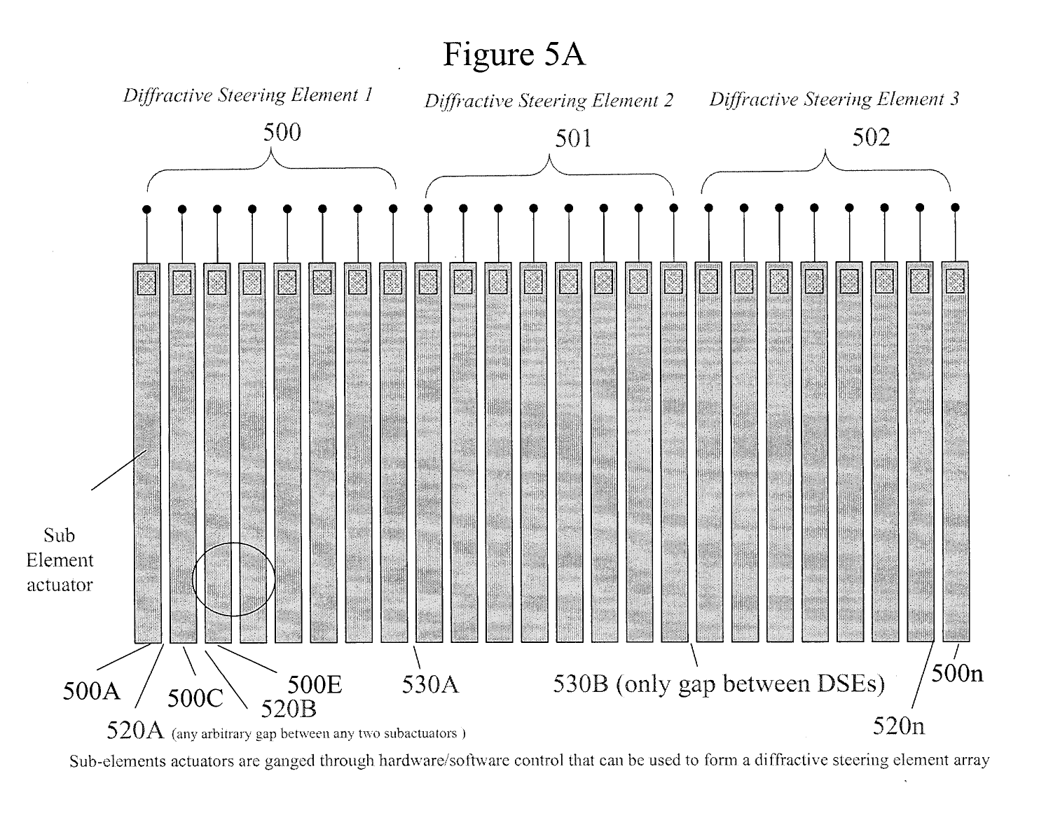

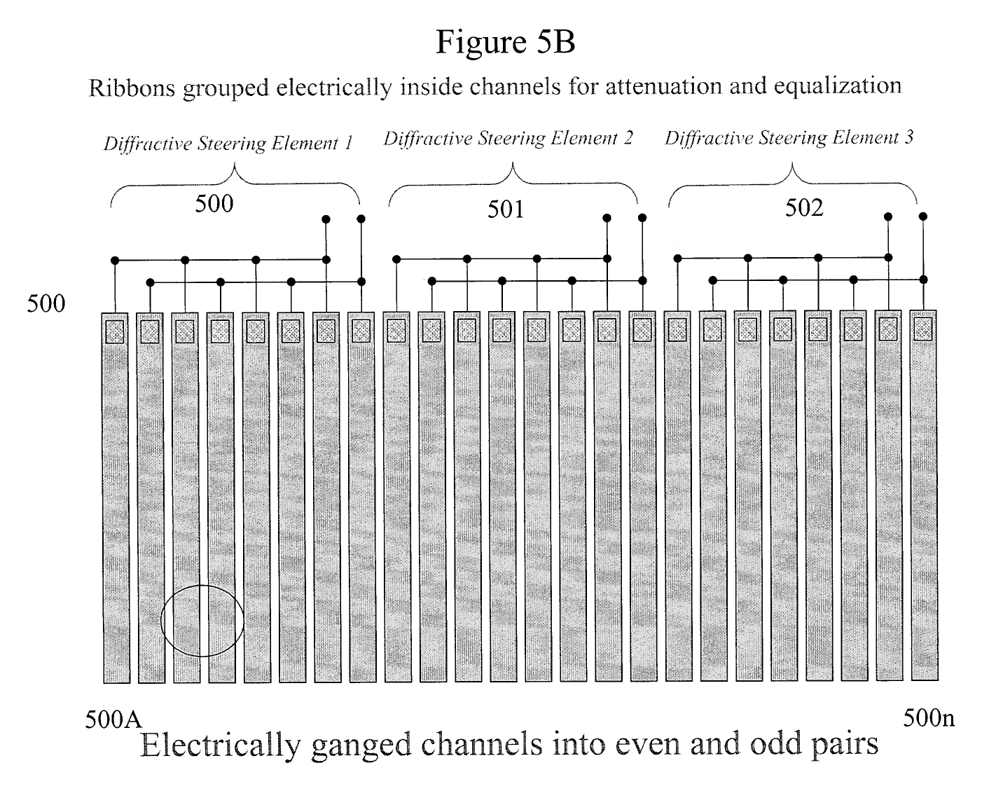

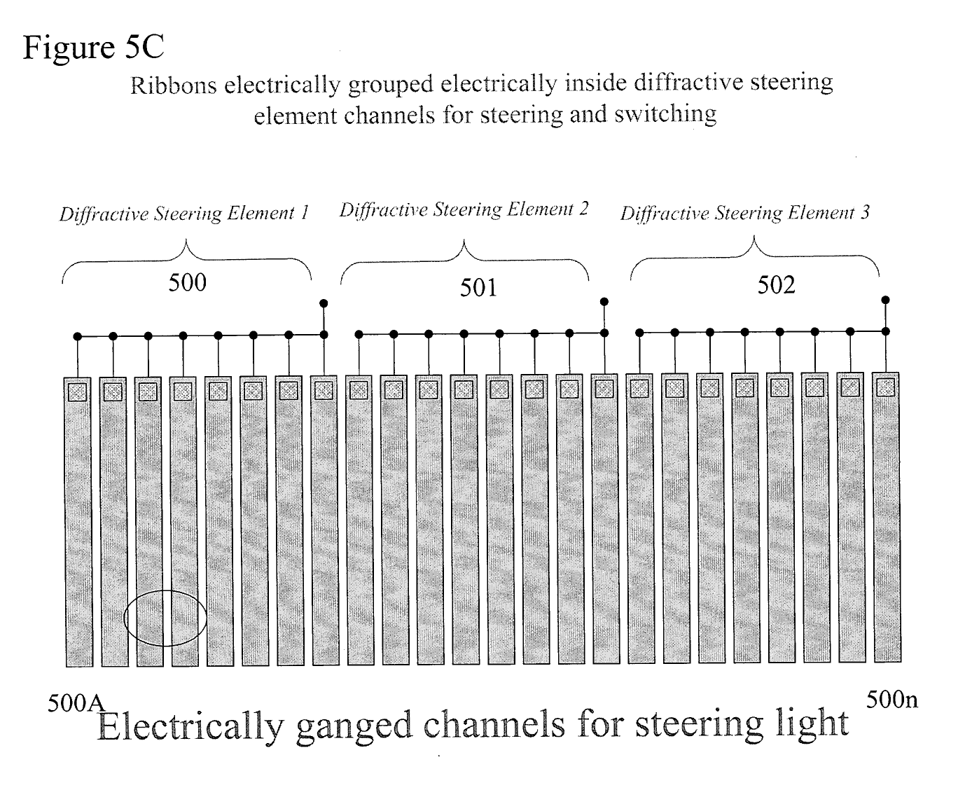

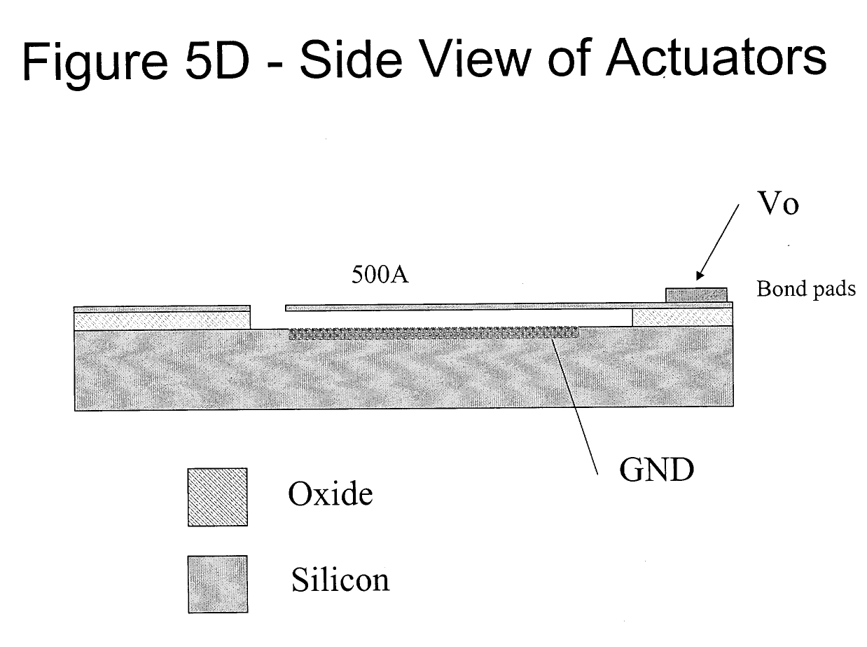

A variety of exemplary designs of diffractive steering elements that can both steer light and provide a seamless interface between the actuators is shown in FIGS. 5A-D, 6A-B and 7. FIGS. 5A-D illustrates one embodiment of three diffractive steering elements, 500,501, 503 based upon the use of electrical or software ganged sub-elements actuators 500A-n . These sub-element actuators 500A-n could be realized in the form of a series of cantilevers, mechanical ribbons, or liquid crystal subelements, each having a mirrored surface 510 and including an array of gaps 520 equal in width to the gaps 530 between the adjacent diffractive steering elements. The number of sub-elements actuators or diffractive steering elements in this example was chosen for visual clarity. It is to be understood that this arrangement could be extended to any number of sub-elements actuators and number of diffractive steering elements. Provided the gaps 520 and 530 are small compared to the width of the reflective subelements 500A-n and the light beam spot size (discussed hereinafter in greater detail) the gaps 520, 530 will introduce a only small optical loss and very little ripple in the attenuation spectrum. Moreover, when the DSE actuators (composed of the ganged subelements) are themselves ganged in pairs the larger actuator looks optically identical to the individual actuators but physically twice as wide, with no discontinuity in the attenuation spectrum in the interface region between actuators.

For the arrangement shown, the width of each cantilever is “a”, the gap between the cantilevers is “b” and the period p=a+b. The filter function is computed by calculating the coupling efficiency from the incident beam originating from the input to the single mode output fiber as a function of the light frequency. For each frequency or wavelength of the light the grating dispersion and lens focal length will determine the position of the optical beam on the cantilever array and for each of these positions the coupling efficiency is computed. The cantilever array will impose on the reflected light beam a phase-front that varies both along the cantilevers and transverse to the cantilevers. Moreover the amplitude of the light will vary as a function of the transverse coordinate because the light that falls in the small gaps will not be reflected and so will form an amplitude grating with a period p.

In addition to seamlessly controlling switching and attenuation of light by steering the light, if the sub-element actuators shown in FIGS. 5A-D are composed of mechanical cantilevers or ribbons, then the diffractive steering elements can also attenuate light based upon control of even and odd pairs of adjacent elements If the subelements 500A-n which make up the diffractive steering element are individually controllable as shown by control nodes 550A-n (best shown in FIG. 5A), it is possible to set the even sub-elements to be at a greater height than the odd elements (keeping in mind the complete diffraction that occurs at the quarter wave height) and so create a phase grating which can attenuate the reflected beam while simultaneously steering the beam. FIG. 5B offers the same degree of control without having to control individual cantilevers by ganging together alternate control nodes 560A-n. The present invention also makes it possible to impose an amplitude grating on a liquid crystal or any spatially dependent amplitude controlling device and, effectively, to eliminate the ripple in the attenuation spectrum while introducing only a modest increase in the insertion loss. The physical structure of the cantilever elements can be best appreciated from the side view of FIG. 5D, where the cantilevered ribbon is disposed above the substrate, and a bond pad provides a connection to a control signal.

In addition to electrically ganging sub-elements or ganging them using software as illustrated in FIGS. 5A-D, it is possible to form mechanical structures which mechanically gang the reflective sub-elements so that they monolithically move together to form one single DSE.

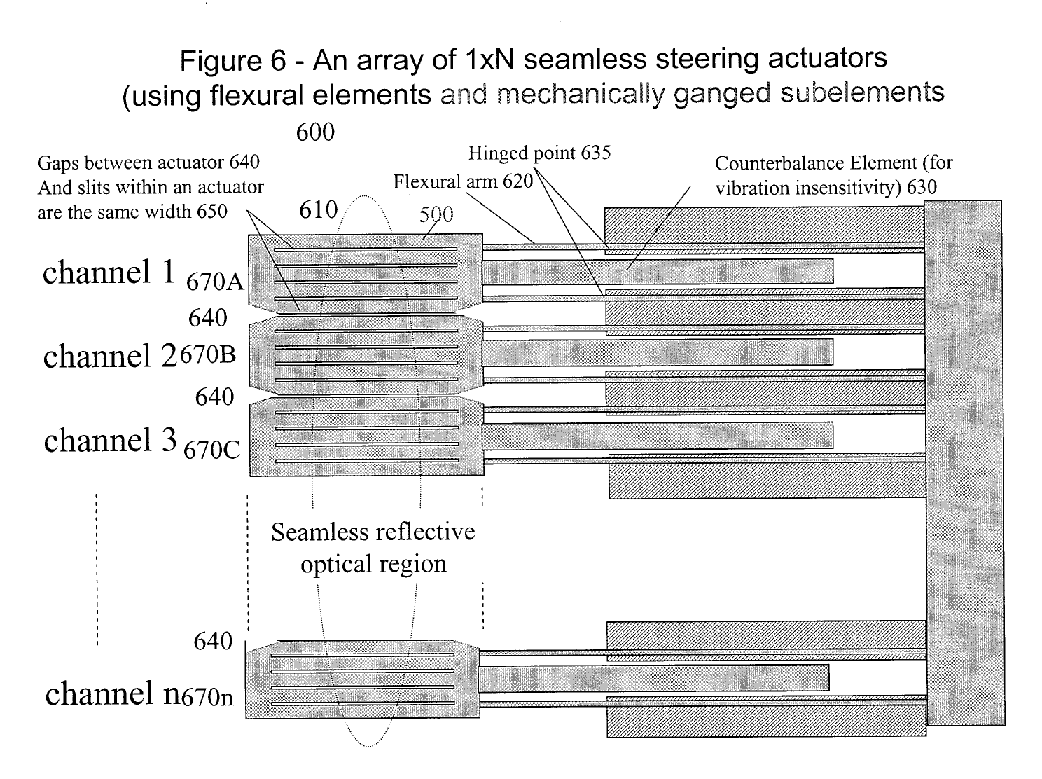

In the alternative arrangement of FIG. 6 actuator 600 includes reflective surfaces 610 and are arranged as a flexure 620 with a counterbalance element 630 to reduce sensitivity to vibrations. The elements rotate at a hinge point 635 The gaps 640 between the actuators 600 and the slits 650 within each DSE actuator are substantially the same width to provide seamless operation across a series of channels 670A-n. Here the slits delineating separate ribbons structures (analogous to the sub-elements discussed in FIGS. 5A-D) but these structures are instead rigidly connected at their ends and this form a single mechanically based DSE.

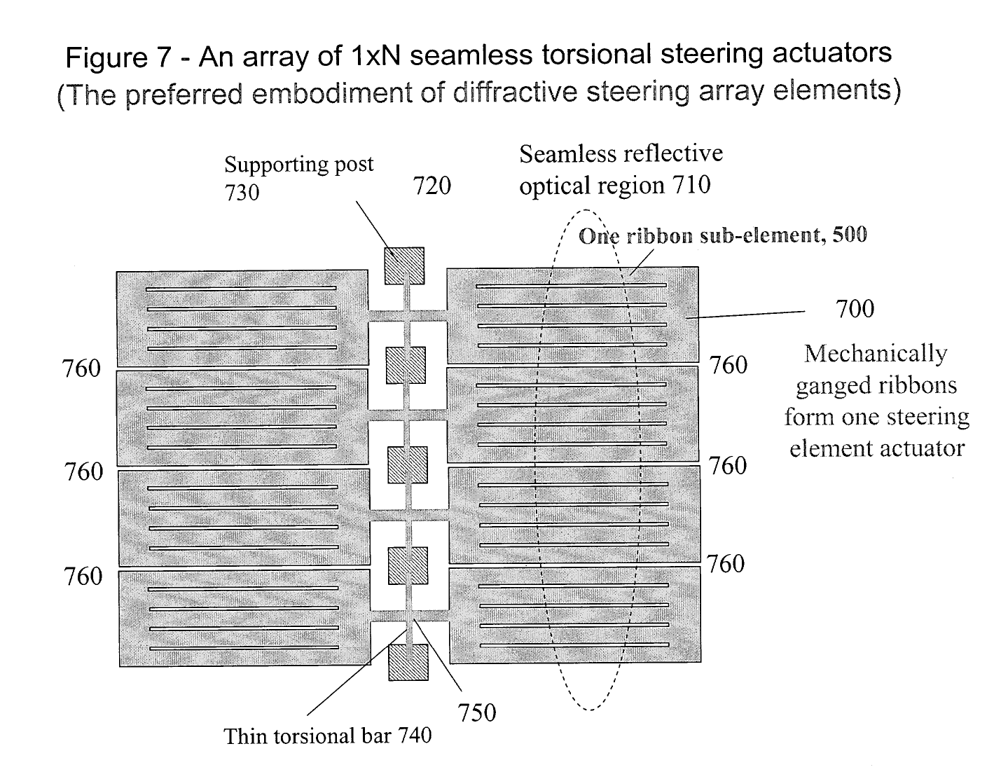

In another preferred embodiment shown in FIG. 7 the reflective surfaces 710 of the actuators 700 are tilted using a torsion mechanism 720 rather than a cantilever. The torsion mechanism, in the illustrated example, can include one or more supporting posts 730 across which extends one or more torsional bars 740, arranged to allow a torsional pivot 750, affixed approximately at the midpoint of the associated bar 740, appropriate movement of the actuators in response to a control signal. To allow the gap 760 between the actuators 700 to remain small, the position of the torsional pivots 750 are contained inside the footprint of the actuator.

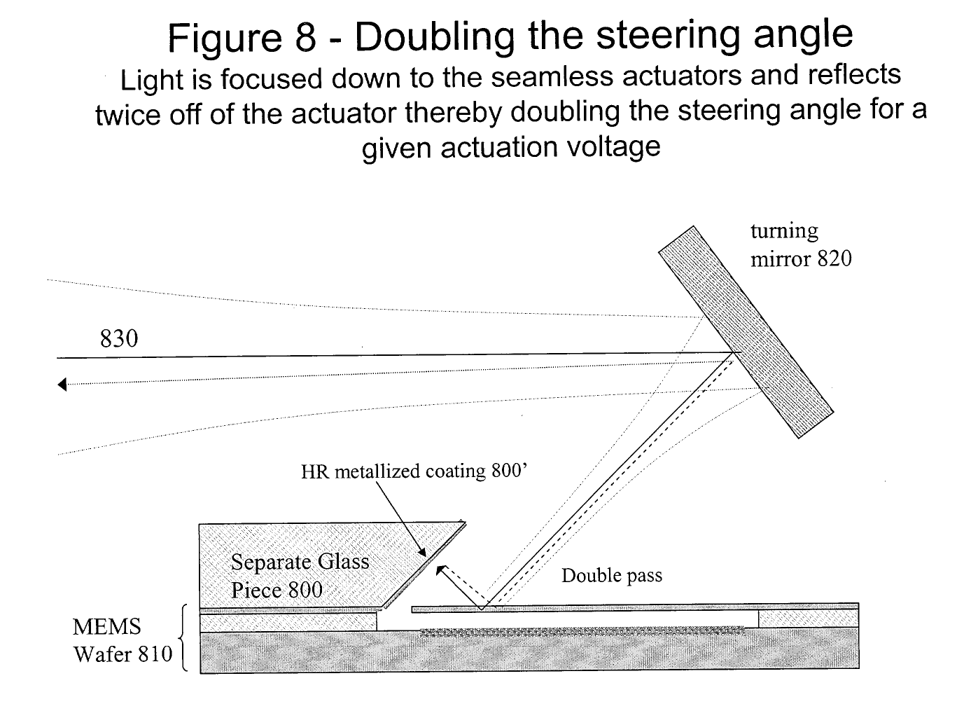

In FIG. 8, a technique for doubling the steering angle achievable by the DSE is shown. In such an arrangement, a beveled material 800 is positioned on or slightly above the MEMS array 810 (shown in side view in FIG. 8),which comprises the DSE. The beveled or angled surface 800′ is mirrored, and a turning mirror 820 is positioned above the reflective surfaces of the MEMS array or wafer 810 such that the incoming light 830 is bounced off the MEMS array 810 toward the mirrored angled surface 800′, after which it bounces back toward the MEMS array 810 and then outward to the turning mirror 820. The steering angle of the resultant beam 830 can be seen to twice that of the original beam, thus increasing the span achievable by the beam when steered.

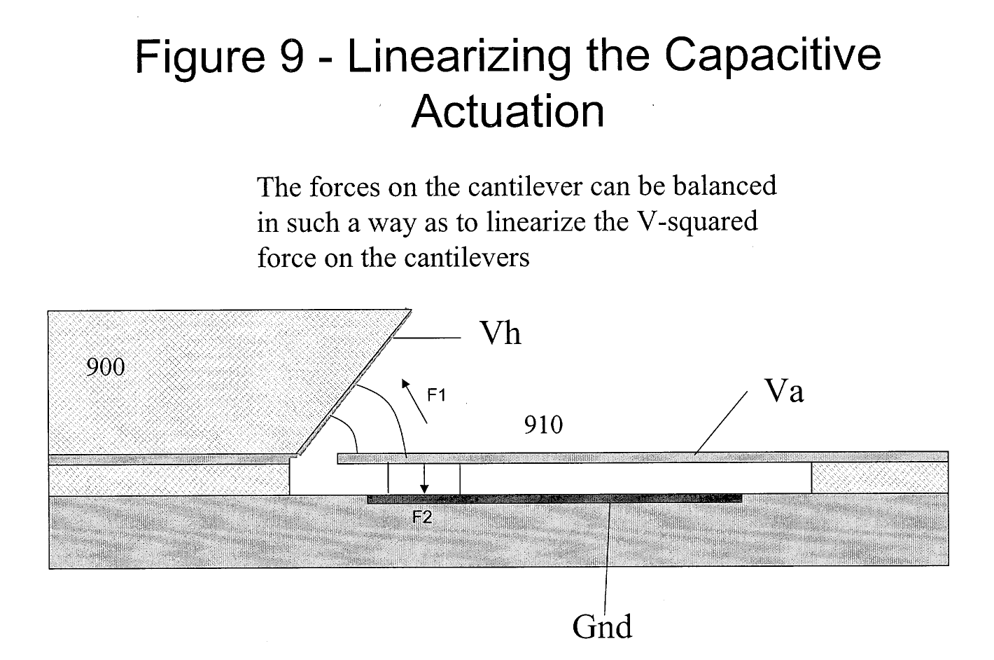

In FIG. 9, a technique for balancing the forces on the cantilever is shown, which permits the V² force on the cantilevers to be linearized. In particular, a material 900 is placed in the same location as the angled mirror 800 of FIG. 8 and above an actuator ribbon 910. A voltage Vh is applied to the material 900 to create a force F1. The actuation voltage Va is applied to the cantilever, causing a downward force F2, which can then be balanced by adjusting Vh. Typically a ground electrode is positioned under the cantilever.

Optical Performance

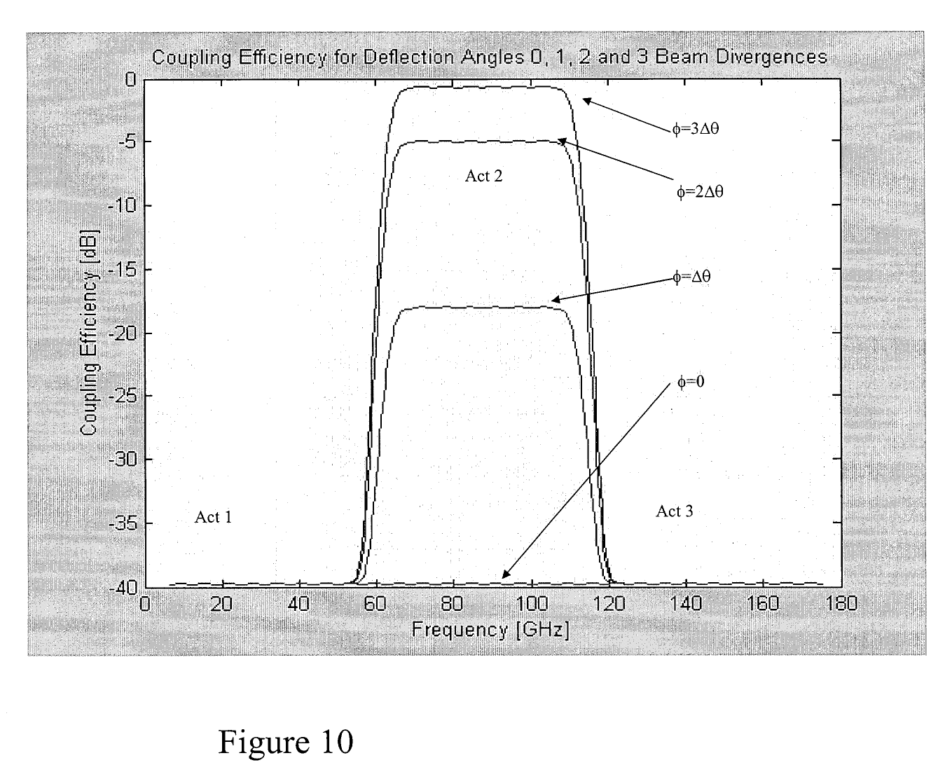

When the cantilevers are not actuated, and so are flat, the light from the input fiber will impinge on the DSE array and be reflected directly back into the input fiber. When a single actuator is energized, the cantilevers comprising that actuator (four cantilevers comprise the exemplary actuator shown) will deflect and redirect the light into a one of four output fibers. FIG. 10 illustrates an exemplary arrangement of three actuators and the coupling efficiency between the input fiber and a single output fiber position. The output fiber is positioned so that an actuator deflection of 3Δθ or three beam divergence angles, Δθ, will produce maximum coupling between the input and the output fiber.

FIG. 10 shows the coupling efficiency for four different cantilever deflections. When the deflection is 0 almost no light is coupled from the input to the output fiber for any frequency. As the deflection is increased to 3Δθ the maximum coupling and so minimum insertion loss is obtained. This figure also demonstrates how an actuator can be used to produce a controlled amount of attenuation between the input fiber and any of the output fibers.

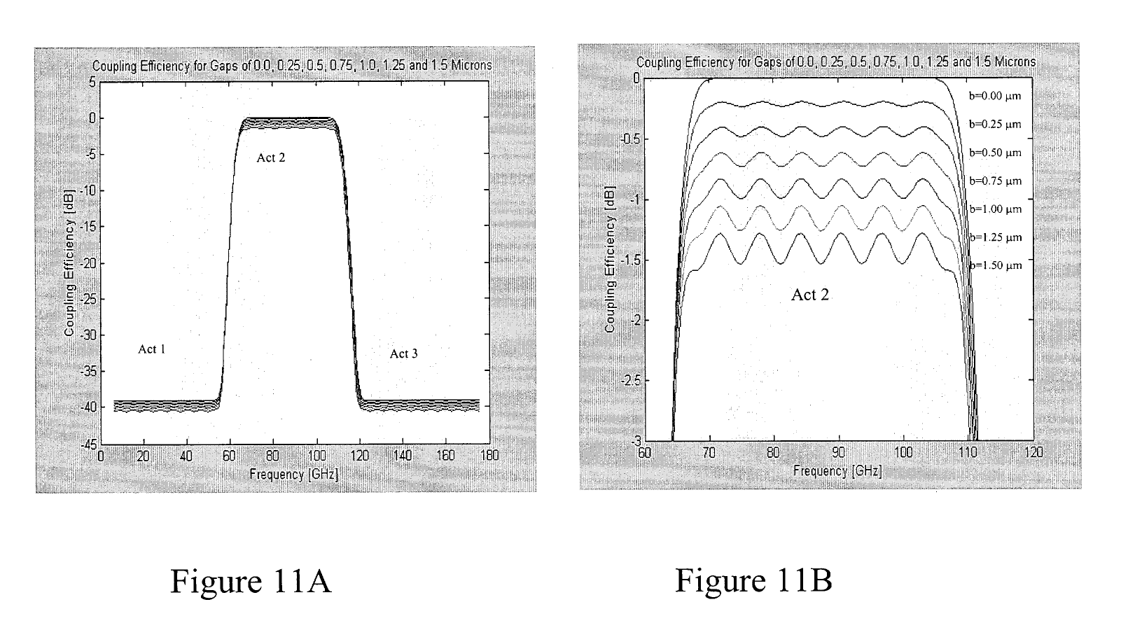

Because the actuators are made from a series of cantilevers with small gaps between them, the attenuation spectrum cannot be perfectly flat across an actuator. However, as the size of the gap is decreased ripples become unimportant. FIG. 11a shows seven plots of the coupling efficiency as a function of frequency for three adjacent actuators. In each of the seven cases the actuator is composed of 8 ribbons, the ribbon width is “a” and the gap is “b”. The period p=a+b is 10 microns in these calculations, although the exact period may be varied according to the frequency be manipulated. The gaps used in the calculations of this example are b=0.25, 0.50, 0.75, 1.00, 1.25 and 1.50 microns and the 1/e² spot size is 8 microns. FIG. 11b shows an expanded version of actuator 2 and shows ripples in the attenuation spectrum at the actuator period, where b=1.50 microns is the bottom curve, and b=0.0 is the top curve.

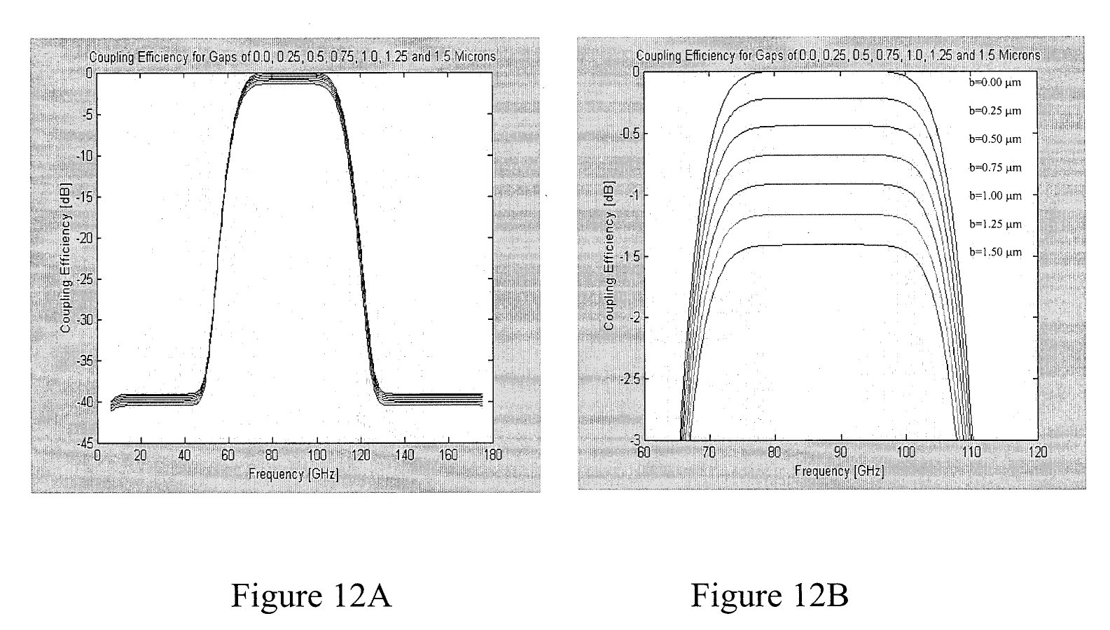

As the width of the gap increases the insertion loss increases along with the spectral ripples caused by the edges of the ribbons. FIGS. 12A-B shows coupling efficiency versus frequency as in FIGS. 11A-B but with a spot size twice as large at 16 microns.

The differences between plots FIGS. 11A-B and 12A-B illustrate some additional aspects which may be utilized in various implementations of the present invention. First, the wings of the attenuation spectra are steeper for the smaller spot as would be expected because less of the optical power spills over between physical actuators. Second the ripples in the attenuation spectra all but disappear in plot of FIG. 12B because the larger spot covers more gaps and so the effects of the gaps are averaged away and so the exact position of these gaps no longer makes a difference. The most interesting point is that the average insertion loss is the same for the two sets of curves and so is only a function of the ribbon width and the gap size but not the light beam spot size in this regime.

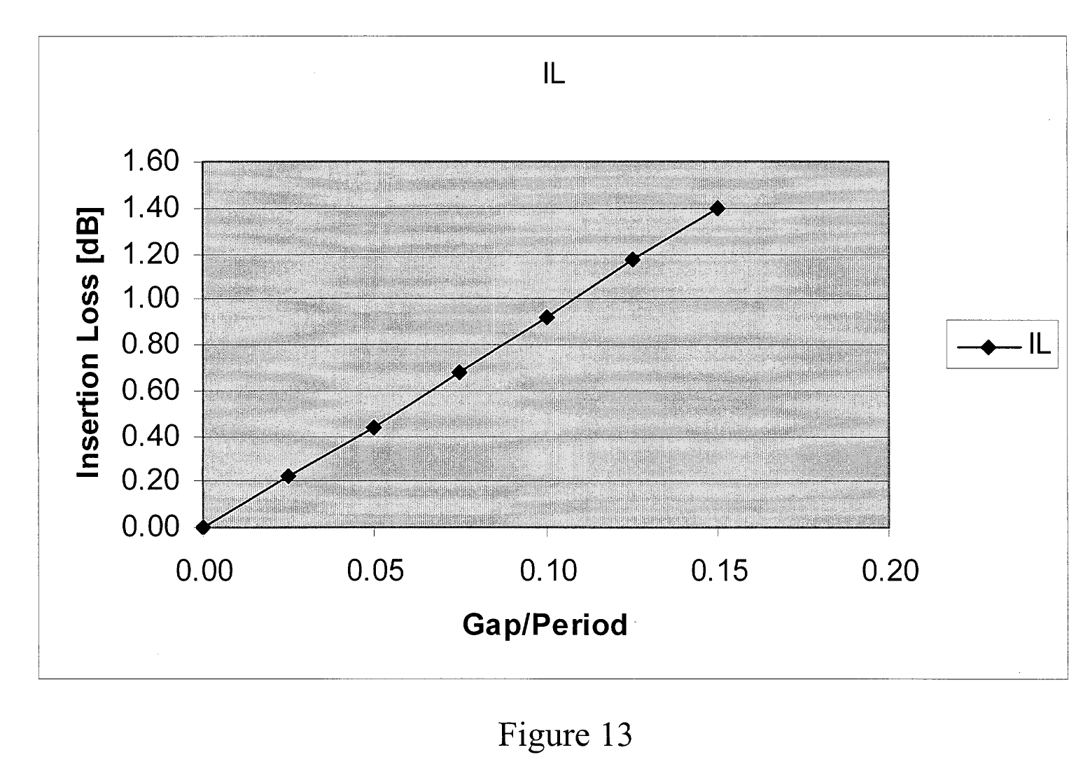

This relationship is plotted in FIG. 13. It can be seen that there is a linear relationship, on a log plot, between the gap/period ratio and the average insertion loss and this relationship is, to the first order, independent of the spot size at the silicon.

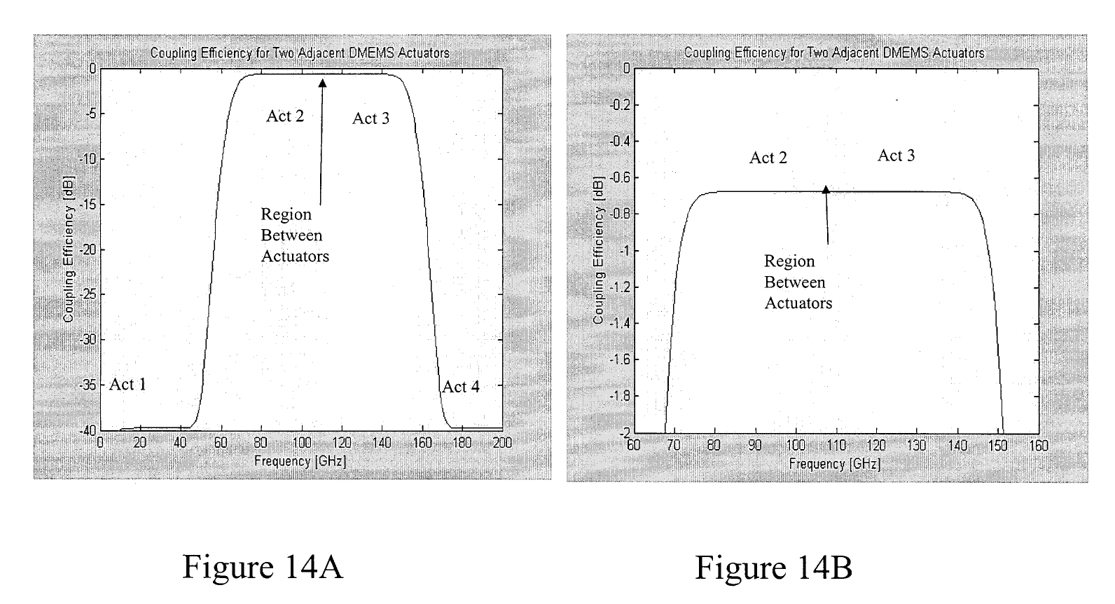

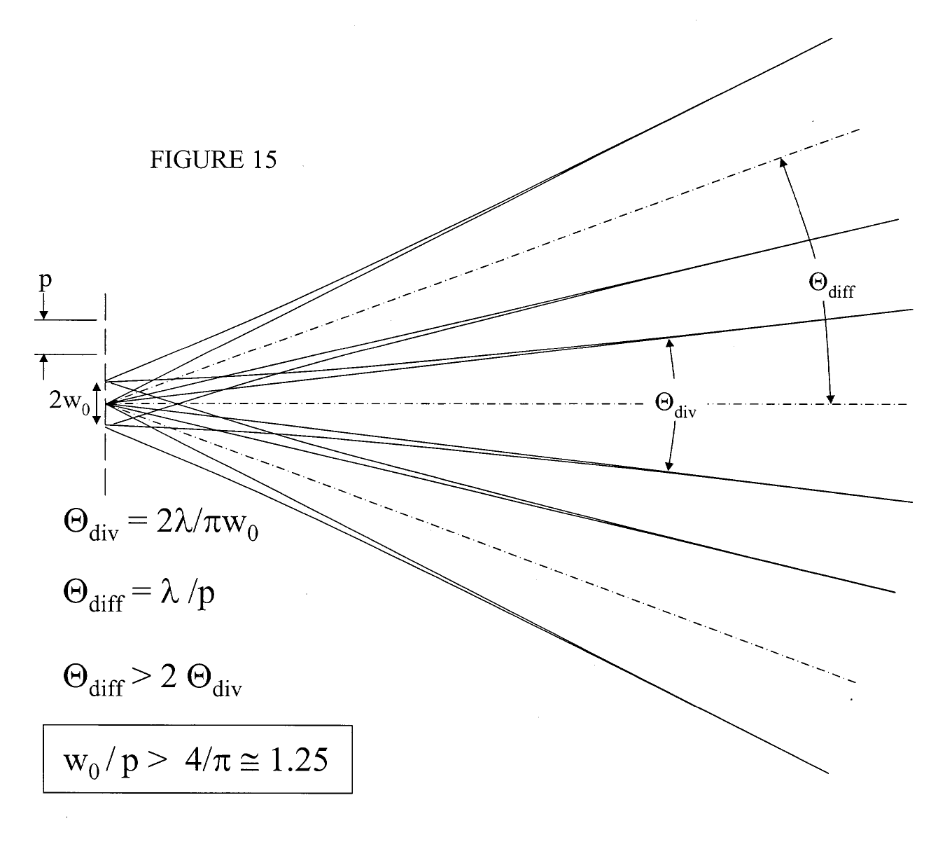

The seamless actuation also holds between two actuators as shown in FIGS. 14A-B. FIG. 14A shows the coupling efficiency versus frequency across four actuators when adjacent actuators 2 and 3 (from FIG. 2, for example) are deflected. Actuators 2 and 3 are adjacent and both are set to couple power from the input fiber to one of the output fibers while actuators 1 and 4 are in their off state and coupling power from the input fiber back into the input fiber.

FIG. 14b is an enlarged view of the region between the two actuators. Note that between the two actuators there is a no change in the character of the attenuation; in other words the actuation is seamless as discussed herein. This would not be the case if we used a single tilting mirror as the actuator, as previously discussed in connection with FIG. 1B.

Referring next to FIG. 16, a generalized optical criteria is shown for eliminating boundary effects such as ripple or other discontinuities. As previously discussed, one key aspect of the present invention is the elimination of boundary effects caused by the transition between actuators. The optical discontinuity or interruption in the optical properties of arrays of optical elements leads to undesirable fluctuations in their optical performance at the boundaries of the optical elements. As long as the resolution of the optical system is several times less than the size of the sub-elements, the impact of the gaps will be a nearly uniform and spatially independent loss of optical efficiency. This loss in efficiency is proportional to the square of the fraction of un-occluded area. In many applications, it is highly desirable to have such “seamless” optical performance at the cost of some loss of optical efficiency.

In operation the diffractive steering element array is illuminated with diffraction limited light. The operation of the apparatus can be understood by considering the operation using a tunable monochromatic light source. For a monochromatic input, a gaussian beam waist is formed at the surface of the diffractive steering element. In operation, for example in the structure of FIG. 4A, as the wavelength of the light is swept, the beam of light moves across the surface of the diffractive steering element array. As long as the spot size of the beam (w₀, the 1/e² intensity radius) is substantially larger than the period (p) then there will be negligible variation or ripple in the optical performance as the beam sweeps across the array. This criteria can be quantified by noting that a gaussian beam's far field full angle of divergence is Θ_{div}=2λ/πw₀, where λ is wavelength of the light. Whereas, the first order angle of diffraction of the periodic structure of the diffractive steering element array is θ_{diff}=λ/p. If θ_{diff}>2θ_{div}, the overlap of power from the diffracted light with the reflective beam is negligible. It is the interference of the light from these diffracted beams that leads to the ripple in the reflected light intensity as the beam is scanned. This criteria leads to the following design rule: if w₀/p>4/π≅1.25, then the reflected optical power will be essentially independent of the beam's position on the array. While this design rule has been described for the specific case of the diffractive steering element array, the rule also applies to other approaches, both reflective and transmissive.

We claim:

1. An optical actuator for use in wave division multiplex signaling comprising
a plurality of ribbons, each having a mirrored upper surface,
each of the plurality of ribbons being separated from the adjacent ribbons by a gap of substantially fixed width,
at least one slit in each of the ribbons, each slit being substantially the same width as the gap.

2. The optical actuator of claim 1 wherein the plurality of ribbons is cantilevered.

3. The optical actuator of claim 1 wherein the plurality of ribbons is flexure mounted.

4. The optical actuator of claim 1 wherein the plurality of ribbons is mounted on torsion bars.

5. An optical system comprising
a plurality of optical actuators, each actuator having a a plurality of ribbons, each having a mirrored upper surface, with each of the plurality of ribbons being separated from the adjacent ribbons by a gap of substantially fixed width, and at least one slit in each of the ribbons, each slit being substantially the same width as the gap, and
a gap between actuators substantially equal in width to the gap between ribbons.

6. The optical system of claim 5 wherein the output across the multiple actuators is seamless.

7. A method for doubling the steering angle of an optical system comprising the steps of
providing a first mirror surface for turning an incoming beam,
providing an optical wafer positioned to receive the turned incoming beam and having a reflective surface for causing a secondary turning of the beam,
providing an angled mirror element disposed to receive the beam after the secondary turning and to reflect the beam back to the reflective surface of the optical wafer.

8. A method for linearing capacitive actuation of a cantilever member comprising
providing a cantilever member movable in response to electrostatic forces,
the cantilever member being caused to dip toward a substrate by a first electrostatic force Va,
providing a second force Vh at a distal end of the cantilever member in opposition to the force Va,
adjusting the force Vh to linearize the actuation of the cantilever member.

9. The system of claim 6 further including having each actuator separately controlled.

10. The system of claim 6 further including having a plurality of actuators ganged for control.
